(19) United States
(12) Patent Application Publication
(10) Pub. No.: US 2021/0070947 A1
(43) Pub. Date: Mar. 11, 2021

(54) AQUEOUS POLYMER, DISPERSION, AND AQUEOUS PAINT

(71) Applicant: INDUSTRIAL TECHNOLOGY RESEARCH INSTITUTE, Hsinchu (TW)

(72) Inventors: Cha-Wen CHANG, Zhongpu Township (TW); Ruo-Han YU, Yilan City (TW); Shinn-Jen CHANG, Hsinchu City (TW); Yu-Hui CHEN, Taipei City (TW); Jen-Yu CHEN, New Taipei City (TW)

(73) Assignee: INDUSTRIAL TECHNOLOGY RESEARCH INSTITUTE, Hsinchu (TW)

(21) Appl. No.: 16/727,535

(22) Filed: Dec. 26, 2019

(30) Foreign Application Priority Data
Sep. 5, 2019 (TW) 108132032

(51) Int. Cl. C08G 81/02; C09D 187/00

(52) U.S. Cl. CPC C08G 81/025; C08K 2003/2244; C08K 2201/003; C09D 187/005

(57) ABSTRACT

An aqueous polymer is provided, which is formed by neutralizing a copolymer modified by polyalkylene glycol with ammonia, primary amine, secondary amine, or a combination thereof, wherein the copolymer is copolymerized from an anhydride monomer with a double bond, a monomer with a double bond, and an initiator. The aqueous polymer can be mixed and dispersed with water and pigment powder to form a dispersion. The dispersion can be mixed with binder to form an aqueous paint.

### CROSS REFERENCE TO RELATED APPLICATIONS

The present application is based on, and claims priority from, Taiwan Application Serial Number 108132032, filed on Sep. 5, 2019, the disclosure of which is hereby incorporated by reference herein in its entirety.

### TECHNICAL FIELD

The technical field relates to an aqueous polymer, and in particular it relates to a dispersion and an aqueous paint containing the aqueous polymer.

### BACKGROUND

The global paint market reached a value of 5.7 trillion NTD in 2018, which white paint was highest traded (about 50%). With improvements in environmental protection awareness, more attention has been paid to the applications of aqueous white slurry (used for primer or color enhancement). White paint needs a white slurry with high tinting ability and high opacity, but these properties are not easily achieved, for the following reasons. Because TiO₂ is easily aggregated and precipitated, it cannot be stably dispersed and not compatible with binder, thereby degrading the paint properties. As such, a dispersant for aqueous white slurry and paint is called for.

### SUMMARY

One embodiment of the disclosure provides an aqueous polymer, being formed by neutralizing a copolymer modified by polyalkylene glycol with ammonia, primary amine, secondary amine, or a combination thereof, wherein the copolymer is copolymerized from an anhydride monomer with a double bond, a monomer with a double bond, and an initiator.

One embodiment of the disclosure provides a dispersion, including: an aqueous polymer; water; and pigment powder, wherein the aqueous polymer is formed by neutralizing a copolymer modified by polyalkylene glycol with ammonia, primary amine, secondary amine, or a combination thereof, wherein the copolymer is copolymerized from an anhydride monomer with a double bond, a monomer with a double bond, and an initiator.

One embodiment of the disclosure provides an aqueous paint, including: a dispersion and a binder, wherein the dispersion includes: an aqueous polymer; water; and pigment powder, wherein the aqueous polymer is formed by neutralizing a copolymer modified by polyalkylene glycol with ammonia, primary amine, secondary amine, or a combination thereof, wherein the copolymer is copolymerized from an anhydride monomer with a double bond, a monomer with a double bond, and an initiator.

A detailed description is given in the following embodiments.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details.

An aqueous polymer provided by embodiments of the disclosure may serve as dispersant. The aqueous polymer can be mixed with water and pigment to form a dispersion. The dispersion can be mixed with a binder to form an aqueous paint.

The aqueous polymer provided by embodiments of the disclosure is formed by neutralizing a copolymer modified by polyalkylene glycol with ammonia, primary amine, secondary amine, or a combination thereof, wherein the copolymer is copolymerized from an anhydride monomer with a double bond, a monomer with a double bond, and an initiator. In one embodiment, the anhydride monomer with a double bond and the monomer with a double bond have a molar ratio of 1:2.3 to 1:0.9. In one embodiment, the anhydride monomer with a double bond can be maleic anhydride, methyl maleic anhydride, dimethyl maleic anhydride, or another suitable monomer. In one embodiment, the monomer with a double bond can be ethylene, propylene, isobutylene, methacrylic acid, acrylic acid, styrene, methyl methacrylate, methyl acrylate, ethyl methacrylate, ethyl acrylate, another suitable monomer, or a combination thereof. In one embodiment, the initiator can be dibenzamidine peroxide, 2,2′-azobisisobutyronitrile, di(t-butyl) peroxide, t-butylhydroperoxide, 1,1′-azo(cyanocyclohexane), 2,5-dimethyl-2,5-bis(t-butyl peroxide) hexane, t-butyl pexoyxbenzoate, cumene hydroperoxide, dicumyl peroxide, lauryl peroxide, t-butyl peroxyacetate, or another suitable initiator. In one embodiment, the polyalkylene glycol and the anhydride monomer have a molar ratio of 0.1:1 to 0.5:1. In one embodiment, the polyalkylene glycol can be polyether monoamine, other suitable polyalkylene glycol, or a combination thereof. It should be noted that if the copolymer modified by the polyalkylene glycol is neutralized with tertiary amine, the aqueous polymer after being heated will undergo obvious yellowing, influencing the color of the final product.

In one embodiment, the aqueous polymer has a chemical structure of

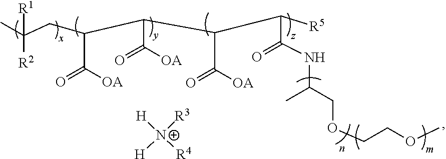

wherein R¹ is H or methyl group, R² is C₆₋₁₂ aryl group, C₃₋₁₂ heteroaryl group, C₂₋₁₀ aliphatic group, —(C═O)—OA, or a combination thereof, R³ is H, C₁₋₄ alkyl group, or C₁₋₄ alkyl alcohol; R⁴ is H, C₁₋₄ alkyl group, or C₁₋₄ alkyl alcohol; R⁵ is H, methyl group, phenyl group, cumyl group, cumyl ester group, cumyl ether group, t-butyl ether group, benzoate group, cyanocyclohexane group, isobutyronitrile group, C₂₋₁₁ alkyl group, C₂₋₁₁ alkyl ester group, C₆₋₁₂ aryl group, C₃₋₁₂ heteroaryl group, or C₂₋₁₀ aliphatic group; each of A is independently ^{⊖} or H, and at last one of A is ^{⊖}. x is 8 to 21; y is 3 to 9; z is 1 to 5; m is 10 to 70; and n is 1 to 13. If x is too low, the polymer cannot be easily adsorbed on the pigment powder. If x is too high, the hydrophilicity of the polymer will be degraded. If y is too low, the hydrophilicity of the polymer will be degraded. If y is too high, the polymer cannot provide efficient steric effect. If z is too low, the hydrophilicity of the polymer will be degraded. If z is too high, the required amount of the polymer will be increased to disperse the pigment powder. If m is too low, the polymer cannot provide efficient steric effect. If m is too high, the dispersable pigment amount will be lowered. If n is too high, the hydrophilicity of the polymer will be degraded.

In one embodiment, 0.1≤z/(y+z)≤0.5, it means that the grafting ratio is 10% to 50%. When z/(y+z) ratio is too high, it means that the grafting ratio of the polyalkylene glycol is too high, and the water resistance of a coating including the aqueous polymer will be poor. When z/(y+z) is too low, it means that the grafting ratio of the polyalkylene glycol is too low, and the pigment powder cannot be efficiently dispersed.

In one embodiment, the aqueous polymer has theoretical number average molecular weight (Mn) of 2500 g/mol to 16000 g/mol. For example, the aqueous polymer may have Mn of 2500 g/mol to 7500 g/mol, 7500 g/mol to 9000 g/mol, 9000 g/mol to 12000 g/mol, or 12000 g/mol to 16000 g/mol. If Mn of the aqueous polymer is too low or too high, the pigment powder cannot be efficiently dispersed.

In one embodiment, the aqueous polymer is synthesized as below. It should be noted that the following method is only for illustration rather than limiting the disclosure. One skilled in the art may adopt applicable apparatuses and chemicals to synthesize the aqueous polymer. First, an anhydride monomer with a double bond and a monomer with a double bond in the presence of dicumyl peroxide (serving as initiator) are copolymerized in cumene (serving as solvent) to form copolymer, as shown below:

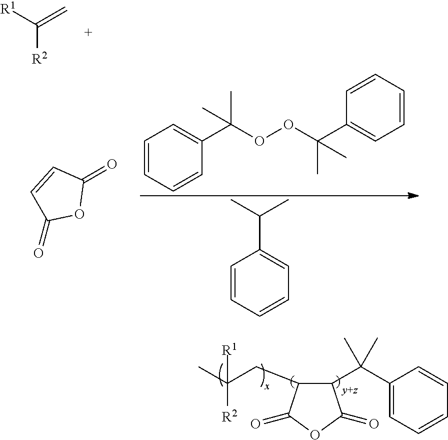

The above polymerization mechanism is radical polymerization, but the disclosure is not limited thereto. For example, one skilled in the art may adopt another initiator to perform the radical polymerization, or another polymerization mechanism such as reversible addition-fragmentation chain transfer (RAFT) polymerization or another applicable polymerization mechanism. The copolymer can be block copolymer, alternating copolymer, or random copolymer. In some embodiments, the copolymer can be directly commercially available rather than self-synthesized.

Subsequently, the copolymer can be modified by polyalkylene glycol (e.g. grafting the polyalkylene glycol to the copolymer), as shown below.

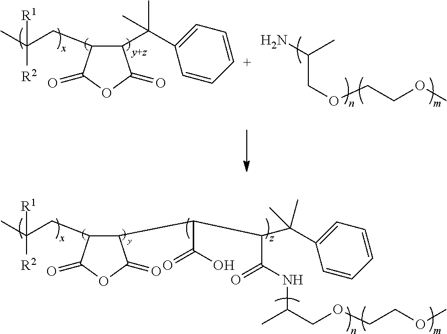

In the above formula, the repeating units corresponding to x, y, and z are arranged in an alternating or random manner rather than in a block manner. In general, the grafting distribution of the polyalkylene glycol is uniform, which is beneficial to uniformly disperse the pigment powder. For example, the aqueous polymer may have a polydispersity index (PDI, Mw/Mn) of 1.3 to 2.0. When the PDI of the aqueous polymer is too high, it exhibits that the grafting positions of the polyalkylene glycol is overly non-uniform, which is unfavorable in the dispersing application.

Subsequently, the copolymer modified by the polyalkylene glycol is neutralized with ammonia, primary amine, secondary amine, or a combination thereof, as shown below.

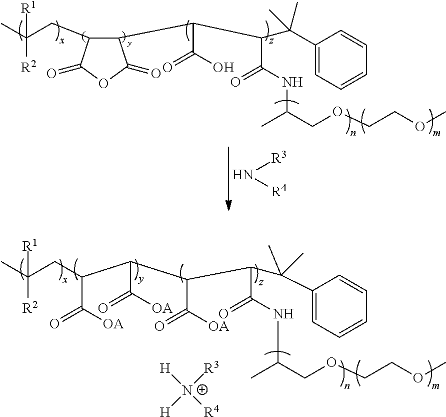

Note that some A may be still H rather than ^{⊖}. In other words, not all —COOH group is neutralized to —COO^{⊖} and NH₂(R³)(R⁴)^{⊕}.

The polymer can be used to disperse pigment powder. For example, a dispersion in one embodiment of the disclosure may contain the aqueous polymer, water, and the pigment powder. In one embodiment, the pigment powders make up 70 wt % to 81 wt % of the dispersion. If the pigment powder ratio is too high, the viscosity of the dispersion will be too high and the too less solvent will be easily dried to precipitate the pigment powder. If the pigment powder ratio is too low, the product practicability will be lowered. In one embodiment, the pigment powder and the active moiety of the aqueous polymer may have a weight ratio of 100:0.4 to 100:3, such as 100:0.4 to 100:1, or 100:1 to 100:3. If the amount of the aqueous polymer is too low, the pigment powder cannot be efficiently dispersed. If the amount of the aqueous polymer is too high, the cost will be increased without further dispersing the pigment powder. In the dispersion, the pigment powder may have an average diameter of 280 nm to 400 nm. In general, the smaller average diameter of the pigment powder is better. In addition, the dispersion may have a viscosity of 30 cps to 100 cps at a rotation speed of 1000 rpm. In addition, the dispersion can be stored at room temperature for a period longer than half year, and the viscosity and the pigment powder diameter thereof are maintained without being greatly changed. Obviously, the dispersion has a very excellent stability.

In addition, the dispersion can be mixed with a binder to form an aqueous paint. The binder can be poly(acrylic acid) resin, polyurethane resin, or a combination thereof. In one embodiment, the dispersion and the binder may have a weight ratio of 30:70 to 55:45. If the amount of the binder is too low, the adhesion of the pigment powder will be degraded. If the amount of the binder is too high, the properties of the pigment powder will be not easily appeared. For example, the dispersion can be mixed with a commercially available binder such as VSR-50 (commercially available from Dow Chemical), ESP-2293 (commercially available from ESP materials), SP3901 (commercially available from Gelie Chemical), or 2026c (commercially available from UNION CHEMICAL IND. CO., LTD.), thereby forming the aqueous paint. The pigment volume concentration (PVC) of the pigment powder in the aqueous paint can be 15% to 30%. If the PVC of the pigment powder is too low, the opacity of the aqueous paint will be lowered. If the PVC of the pigment powder is too high, the paint gloss will be degraded. In the aqueous paint, the average diameter of the pigment powder can be 280 nm to 500 nm. In general, if the average diameter of the pigment powder in the aqueous paint is greatly larger than the average diameter of the pigment powder in the dispersion, the dispersant (such as the aqueous polymer) and the binder may have a poor compatibility. In some embodiments, the average diameter of the pigment powder in the aqueous paint and the average diameter of the pigment powder in the dispersion may have a difference of less than 5%.

The aqueous paint is coated on a substrate and then baking dried to form a film having excellent gloss and opacity. On the other hand, the aqueous polymer has a low yellowing degree after being heated. In short, the aqueous polymer of the disclosure is an appropriate dispersant for the pigment powder, and the dispersion containing the aqueous polymer is proper to prepare the aqueous paint.

In the described embodiments, the pigment powder can be TiO₂ powder serving as white pigment. However, the aqueous polymer is not limited to disperse the TiO₂ powder. For example, the pigment powder can be yellow inorganic pigment such as cadmium yellow (PY35, C.I. 77205, CAS No.:12237-67-1), titanium nickel yellow (PY53, C.I.77788, CAS No.:8007-18-9), praseodymium zirconium yellow (PY159, C.I.77997, CAS No.:68187-15-5), chromium titanium yellow (PY162, C.I.77896, CAS No.:68611-42-7; PY163, C.I.77897, CAS No.:68186-92-5), or bismuth yellow (PY184, C.I.771740, CAS No.:14059-33-7); magenta inorganic pigment such as iron red (PR101, C.I.77491, CAS #1317-60-8), cadmium red (PR108, C.I.77202, CAS No.:58339-34-7), lead chromium red (PR104, C.I.77605, CAS No.:12656-85-8; PR105, C.I.77578, CAS No.:1314-41-6), or iron zirconium red (PR232, C.I.77996, CAS No.:68412-79-3); cyan inorganic pigment such as cobalt blue (PB28, C.I.77364, CAS No.:68187-40-6) or cobalt chromium blue (PB36, C.I.77343, CAS No.:68187-11-1); black inorganic pigment such as manganese iron black (PBK26, C.I.77494, CAS No.:68186-94-7; PBK33, C.I.77537, CAS No.:75864-23-2), cobalt iron chromium black (PBK27, C.I.77502, CAS No.:68186-97-0), copper chromium black (PBK28, C.I.77428, CAS No.:68186-91-4), chromium iron black (PBK30, C.I.77504, CAS No.:71631-15-7), or titanium black (PBK35, C.I.77890, CAS No.:70248-09-8); white inorganic pigment such as titanium white (PW6, C.I.77891, CAS No.:13463-67-7), zirconium white (PW12, C.I.77990, CAS No.:1314-23-4), or zinc white (PW4, C.I.77947, CAS No.:1314-13-2); orange inorganic powder such as cadmium orange (P020, C.I.77199, CAS No.:12656-57-4) or orange chromium yellow (P021, C.I.77601, CAS No.:1344-38-3); or green inorganic pigment such as chromium green (PG17, C.I.77288, CAS No.:1308-38-9), cobalt green (PG19, C.I.77335, CAS No.:8011-87-8), cobalt chromium green (PG26, C.I.77344, CAS No.:68187-49-5), or cobalt titanium green (PG50, C.I.77377, CAS No.:68186-85-6). The pigment powder can be another suitable pigment, and not limited to the described pigments.

Below, exemplary embodiments will be described in detail so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### EXAMPLES

### Example 1-1 (Aqueous Polymer 1d)

79 g of SMA® 2000 (26 mmole, commercially available from Cray Valley) was added to 200 mL of methyl ethyl ketone (MEK) under nitrogen, and then heated and stirred until SMA® 2000 was completely dissolved in MEK. On the other hand, 494 g of polyether monoamine SURFONAMINE® L-207 (247 mmole, commercially available from Huntsman) was added to 100 mL of MEK, and then heated and stirred until SURFONAMINE® L-207 was completely dissolved in MEK. The SURFONAMINE® L-207 solution was added to SMA® 2000 solution at 85° C. and reacted for 12 hours. The solvent of the reaction result was removed by rotatory evaporator, and the concentrate was added to 912 g of water and 16 g of ammonia (28%), and then stirred to be completely dissolved to obtain a dispersant (e.g. aqueous polymer 1d, solid content: 38.4%). The grafting ratio of SURFONAMINE® L-207 was 100%, and the acid value of the dispersant was about 20 mgKOH/g to 40 mgKOH/g. The reaction is shown below, and x, y, z, m, n, and A correspond to the composition and amount of the reactants. x is about 19 to 21, y is about 0, z is about 9 to 11, m is about 30 to 32, n is about 10 to 12, and A is ^{⊖}. The IR spectrum of SMA® 2000 had C═O signal (1778 cm⁻¹) of the maleic anhydride. The IR spectrum of the intermediate product of the above reaction had NH and COOH signal (3463 cm⁻¹), CH₂ signal (2881 cm⁻¹), C═O signal of amide bond (1643 cm⁻¹), and C—O—C signal (1103 cm⁻¹). As seen in the IR spectra, the SURFONAMINE® L-207 and the maleic anhydride of SMA® 2000 were reacted to perform ring-opening addition.

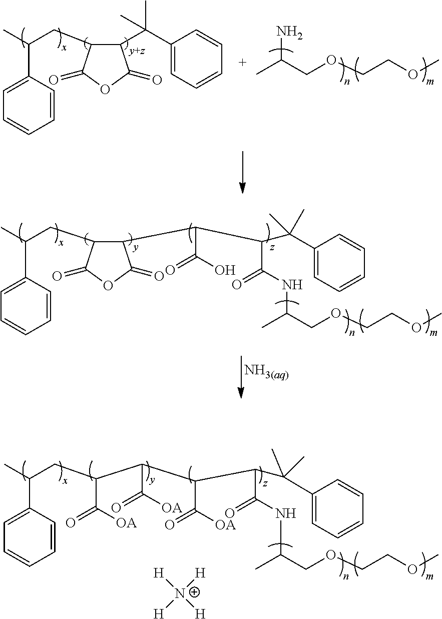

### Example 1-2 (Aqueous Polymer 2d)

80 g of SMA® 1000 (40 mmole, commercially available from Cray Valley) was added to 200 mL of tetrahydrofuran (THF) under nitrogen, and then heated and stirred until SMA® 1000 was completely dissolved in THF. On the other hand, 120 g of polyether monoamine SURFONAMINE® L-300 (40 mmole, commercially available from Huntsman) was added to 100 mL of THF, and then heated and stirred until SURFONAMINE® L-300 was completely dissolved in THF. The SURFONAMINE® L-300 solution was added to SMA® 1000 solution at 50° C. and reacted for 18 hours. The solvent of the reaction result was removed by rotatory evaporator, and the concentrate was added to 168 g of water and 43 g of ammonia (28%), and then stirred to be completely dissolved to obtain a dispersant (e.g. aqueous polymer 2d, solid content: 48.7%). The grafting ratio of SURFONAMINE® L-300 was about 10%, and the acid value of the dispersant was about 170 mgKOH/g to 190 mgKOH/g. The reaction can refer to the reaction formula in Example 1-1, and x, y, z, m, n, and A correspond to the composition and amount of the reactants. x is about 9 to 12, y is about 7 to 9, z is about 1, m is about 57 to 60, n is about 7 to 9, and A is ^{⊖}.

### Example 1-3 (Aqueous Polymer 3d)

50 g of SMA® 1000 (25 mmole) was added to 100 mL of THE under nitrogen, and then heated and stirred to completely dissolve SMA® 1000 in THF. On the other hand, 100 g of polyether monoamine SURFONAMINE® L-200 (50 mmole, commercially available from Huntsman) was added to 70 mL of THF, and then heated and stirred to completely dissolve SURFONAMINE® L-200 in THF. The SURFONAMINE® L-200 solution was added to SMA® 1000 solution at 50° C. and reacted for 18 hours. The solvent of the reaction result was removed by rotatory evaporator, and the concentrate was added to 121 g of water and 17 g of ammonia (28%), and then stirred to be completely dissolved to obtain a dispersant (e.g. aqueous polymer 3d, solid content: 52.0%). The grafting ratio of SURFONAMINE® L-200 was about 20%, and the acid value of the dispersant was about 130 mgKOH/g to 150 mgKOH/g. The reaction can refer to the reaction formula in Example 1-1, and x, y, z, m, n, and A correspond to the composition and amount of the reactants. x is about 9 to 12, y is about 6 to 8, z is about 2, m is about 39 to 42, n is about 2 to 4, and A is ^{⊖}.

### Example 1-4 (Aqueous Polymer 4d)

80 g of SMA® 1000 (40 mmole) was added to 100 mL of TH under nitrogen, and then heated and stirred to completely dissolve SMA® 1000 in THF. On the other hand, 80 g of polyether monoamine SURFONAMINE® L-100 (80 mmole, commercially available from Huntsman) was added to 100 mL of THF, and then heated and stirred to completely dissolve SURFONAMINE® L-100 in THF. The SURFONAMINE® L-100 solution was added to SMA® 1000 solution at 50° C. and reacted for 18 hours. The solvent of the reaction result was removed by rotatory evaporator, and the concentrate was added to 139 g of water and 31 g of ammonia (28%), and then stirred to be completely dissolved to obtain a dispersant (e.g. aqueous polymer 4d, solid content: 48.5%). The grafting ratio of SURFONAMINE® L-100 was about 20%, and the acid value of the dispersant was about 200 mgKOH/g to 220 mgKOH/g. The reaction can refer to the reaction formula in Example 1-1, and x, y, z, m, n, and A correspond to the composition and amount of the reactants. x is about 9 to 12, y is about 6 to 8, z is about 2, m is about 18 to 21, n is about 2 to 3, and A is ^{⊖}.

### Example 1-5 (Aqueous Polymers 5d and 5d″)

200 g of SMA® 1000 (100 mmole) was added to 200 mL of MEK under nitrogen, and then heated and stirred to completely dissolve SMA® 1000 in MEK. On the other hand, 300 g of polyether monoamine SURFONAMINE® L-100 (300 mmole) was added to 100 mL of MEK, and then heated and stirred to completely dissolve SURFONAMINE® L-100 in MEK. The SURFONAMINE® L-100 solution was added to SMA® 1000 solution at 50° C. and reacted for 18 hours. The solvent of the reaction result was removed by rotary evaporator, and 300 g of the concentrate was added to 303 g of water and 56 g of ammonia (28%), and then stirred to be completely dissolved to obtain a dispersant (e.g. aqueous polymer 5d, solid content: 45.5%). The grafting ratio of SURFONAMINE® L-100 was about 30%, and the acid value of the dispersant was about 150 mgKOH/g to 170 mgKOH/g. The reaction can refer to the reaction formula in Example 1-1, and x, y, z, m, n, and A correspond to the composition and amount of the reactants. x is about 9 to 12, y is about 5 to 7, z is about 3, m is about 18 to 21, n is about 2 to 3, and A is ^{⊖}.

On the other hand, 100 g of the concentrate was added to 67 g of water and 46 g of triethanolamine, and then stirred to be completely dissolved to obtain a dispersant (e.g. aqueous polymer 5d″, solid content: 47.0%). The reaction is shown below, and x, y, z, m, n, and A correspond to the composition and amount of the reactants. x is about 9 to 12, y is about 5 to 7, z is about 3, m is about 18 to 21, n is about 2 to 3, and A is ^{⊖}.

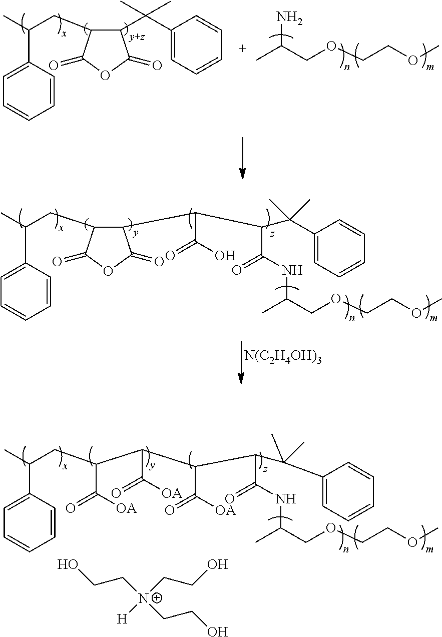

### Example 2-1 (Aqueous Dispersion LAW294a)

Commercially available dispersant Disperbyk-190 (commercially available from BYK), TiO₂ powder (Kronos 2360), and water were stirred to pre-disperse. Zirconia beads were added to the pre-dispersion, and the above mixture was put into a LAU miller to be dispersed by vibration at room temperature for 8 hours. After the vibration was completed, the vibrated result was filtered through a filtering cloth with pores of 25 m to obtain white slurry (Aqueous dispersion LAW294a). In the white slurry, TiO₂ occupied 76.5 wt %, the commercially available dispersant Disperbyk-190 occupied 0.765 wt %, and water occupied the remaining part.

### Example 2-2 (Aqueous Dispersion LAW295a)

Commercially available dispersant Disperbyk-199 (commercially available from BYK), TiO₂ powder (Kronos 2360), and water were stirred to pre-disperse. Zirconia beads were added to the pre-dispersion, and the above mixture was put into a LAU miller to be dispersed by vibration at room temperature for 8 hours. After the vibration was completed, the vibrated result was filtered through a filtering cloth with pores of 25 m to obtain white slurry (Aqueous dispersion LAW295a). In the white slurry, TiO₂ occupied 76.5 wt %, the commercially available dispersant Disperbyk-199 occupied 0.765 wt %, and water occupied the remaining part.

### Example 2-3 (Aqueous Dispersion LAW247a)

The aqueous polymer 1d serving as dispersant, TiO₂ powder (Kronos 2360), and water were stirred to pre-disperse. Zirconia beads were added to the pre-dispersion, and the above mixture was put into a LAU miller to be dispersed by vibration at room temperature for 8 hours. After the vibration was completed, the vibrated result was filtered through a filtering cloth with pores of 25 m to obtain white slurry (Aqueous dispersion LAW247a). In the white slurry, TiO₂ occupied 76.5 wt %, the aqueous polymer 1d occupied 0.765 wt %, and water occupied the remaining part.

### Example 2-4 (Gel LAW261a)

Commercially available dispersant Disperbyk-190 (commercially available from BYK), TiO₂ powder (Kronos 2360), and water were stirred to pre-disperse. Zirconia beads were added to the pre-dispersion, and the above mixture was put into a LAU miller to be dispersed by vibration at room temperature for 8 hours. After the vibration was completed, the vibrated result was gelled (Gel LAW261a) and could not be filtered through a filtering cloth with pores of 25 μm. In the gel, TiO₂ occupied 80 wt %, the commercially available dispersant Disperbyk-190 occupied 0.4 wt %, and water occupied the part that remained.

### Example 2-5 (Gel LAW263a)

Commercially available dispersant Disperbyk-199 (commercially available from BYK), TiO₂ powder (Kronos 2360), and water were stirred to pre-disperse. Zirconia beads were added to the pre-dispersion, and the above mixture was put into a LAU miller to be dispersed by vibration at room temperature for 8 hours. After the vibration was completed, the vibrated result was gelled (Gel LAW263a) and could not be filtered through a filtering cloth with pores of 25 m. In the gel, TiO₂ occupied 80 wt %, the commercially available dispersant Disperbyk-199 occupied 0.4 wt %, and water occupied the remaining part.

### Example 2-6 (Aqueous Dispersion LAW289a)

The aqueous polymer 2d serving as dispersant, TiO₂ powder (Kronos 2360), and water were stirred to pre-disperse. Zirconia beads were added to the pre-dispersion, and the above mixture was put into a LAU miller to be dispersed by vibration at room temperature for 8 hours. After the vibration was completed, the vibrated result was filtered through a filtering cloth with pores of 25 m to obtain white slurry (Aqueous dispersion LAW289a). In the white slurry, TiO₂ occupied 76.5 wt %, the aqueous polymer 2d occupied 0.765 wt %, and water occupied the remaining part.

### Example 2-7 (Aqueous Dispersion LAW273a)

Commercially available dispersant Solsperse™ 20000 (commercially available from Lubrizol), TiO₂ powder (Kronos 2360), and water were stirred to pre-disperse. Zirconia beads were added to the pre-dispersion, and the above mixture was put into a LAU miller to be dispersed by vibration at room temperature for 8 hours. After the vibration was completed, the vibrated result was filtered through a filtering cloth with pores of 25 m to obtain white slurry (Aqueous dispersion LAW273a). In the white slurry, TiO₂ occupied 76.5 wt %, the commercially available dispersant Solsperse™ 20000 occupied 0.765 wt %, and water occupied the remaining part.

### Example 2-8 (Aqueous Dispersion LAW290a)

The aqueous polymer 3d serving as dispersant, TiO₂ powder (Kronos 2360), and water were stirred to pre-disperse. Zirconia beads were added to the pre-dispersion, and the above mixture was put into a LAU miller to be dispersed by vibration at room temperature for 8 hours. After the vibration was completed, the vibrated result was filtered through a filtering cloth with pores of 25 m to obtain white slurry (Aqueous dispersion LAW290a). In the white slurry, TiO₂ occupied 76.5 wt %, the aqueous polymer 3d occupied 0.765 wt %, and water occupied the remaining part.

### Example 2-9 (Aqueous Dispersion LAW292a)

The aqueous polymer 4d serving as dispersant, TiO₂ powder (Kronos 2360), and water were stirred to pre-disperse. Zirconia beads were added to the pre-dispersion, and the above mixture was put into a LAU miller to be dispersed by vibration at room temperature for 8 hours. After the vibration was completed, the vibrated result was filtered through a filtering cloth with pores of 25 m to obtain white slurry (Aqueous dispersion LAW292a). In the white slurry, TiO₂ occupied 76.5 wt %, the aqueous polymer 4d occupied 0.765 wt %, and water occupied the remaining part.

### Example 2-10 (Aqueous Dispersion LAW293a)

Commercially available dispersant Dispex® Ultra PX 4575 (commercially available from BASF), TiO₂ powder (Kronos 2360), and water were stirred to pre-disperse. Zirconia beads were added to the pre-dispersion, and the above mixture was put into a LAU miller to be dispersed by vibration at room temperature for 8 hours. After the vibration was completed, the vibrated result was filtered through a filtering cloth with pores of 25 m to obtain white slurry (Aqueous dispersion LAW293a). In the white slurry, TiO₂ occupied 76.5 wt %, the commercially available dispersant Dispex® Ultra PX 4575 occupied 0.765 wt %, and water occupied the remaining part.

### Example 2-11 (Aqueous Dispersion LAW346a)

The aqueous polymer 5d serving as dispersant, TiO₂ powder (Kronos 2360), and water were stirred to pre-disperse. Zirconia beads were added to the pre-dispersion, and the above mixture was put into a LAU miller to be dispersed by vibration at room temperature for 8 hours. After the vibration was completed, the vibrated result was filtered through a filtering cloth with pores of 25 m to obtain white slurry (Aqueous dispersion LAW346a). In the white slurry, TiO₂ occupied 76.5 wt %, the aqueous polymer 5d occupied 0.765 wt %, and water occupied the remaining part.

### Example 2-12 (Aqueous Dispersion LAW353a)

The aqueous polymer 5d serving as dispersant, TiO₂ powder (Kronos 2360), and water were stirred to pre-disperse. Zirconia beads were added to the pre-dispersion, and the above mixture was put into a LAU miller to be dispersed by vibration at room temperature for 8 hours. After the vibration was completed, the vibrated result was filtered through a filtering cloth with pores of 25 m to obtain white slurry (Aqueous dispersion LAW353a). In the white slurry, TiO₂ occupied 80.0 wt %, the aqueous polymer 5d occupied 0.4 wt %, and water occupied the remaining part.

The average diameter (Dₐᵥₑ), D₅₅, and D₁₀₀ of solid particles (e.g. TiO₂) of the aqueous dispersions, and the viscosity of the aqueous dispersions at a rotation speed of 100 rpm and a temperature of 25° C. were measured, as tabulated in Table 1.

TABLE 1

| | | | Dₐᵥₑ | D₉₅ | D₁₀₀ | η |
|---|---|---|---|---|---|---|
| Example | Dispersion | Dispersant | (nm) | (nm) | (nm) | (cps) |
| 2-1 | LAW294a | BYK190 | 337 | 591 | 825 | 49 |
| 2-2 | LAW295a | BYK199 | 339 | 611 | 955 | 55 |
| 2-3 | LAW247a | 1d | 507 | 1020 | 1720 | 120 |
| 2-6 | LAW289a | 2d | 351 | 673 | 825 | 56 |
| 2-7 | LAW273a | Lubrizol20000 | 404 | 712 | 1110 | 86 |
| 2-8 | LAW290a | 3d | 313 | 694 | 1280 | 41 |
| 2-9 | LAW292a | 4d | 327 | 601 | 1110 | 47 |
| 2-10 | LAW293a | BASF4575 | 685 | 1180 | 1720 | 55 |
| 2-11 | LAW346a | 5d | 292 | 516 | 712 | 32 |
| 2-12 | LAW353a | 5d | 331 | 758 | 1480 | 63 |

| | | | | | |
|---|---|---|---|---|---|
| Commercially available white | — | 319 | 516 | 712 | 37 |
| slurry Kronos 4311 | | | | | |

As shown above, the aqueous polymers having a lower grafting ratio (e.g. the aqueous polymers 2d, 3d, 4d, and 5d) serving as the dispersant prepared in Examples of the disclosure had a better dispersing effect for TiO₂ powder. The aqueous polymers having a higher grafting ratio (e.g. the aqueous polymers 1d) serving as the dispersant prepared in Example of the disclosure and the commercially available dispersant had a worse dispersing effect for TiO₂ powder (e.g. larger average diameter).

### Example 3-1 (Aqueous White Paint S13)

6.6 g of the commercially available white slurry Kronos 4311 and 13.4 g of acrylic acid-type binder VSR-50 were mixed, in which the pigment volume concentration was 18%. The mixture was stirred at a rotation speed of 800 rpm to 1000 rpm for 0.5 hours to obtain an aqueous white paint S13.

### Example 3-2 (Aqueous White Paint S14)

9.4 g of the commercially available white slurry Kronos 4311 and 10.6 g of the acrylic acid-type binder VSR-50 were mixed, in which the pigment volume concentration was 28%. The mixture was stirred at a rotation speed of 800 rpm to 1000 rpm for 0.5 hours to obtain an aqueous white paint S14.

### Example 3-3 (Aqueous White Paint S35)

9.3 g of the aqueous dispersion LAW294a and 10.7 g of the acrylic acid-type binder VSR-50 were mixed, in which the pigment volume concentration was 28%. The mixture was stirred at a rotation speed of 800 rpm to 1000 rpm for 0.5 hours to obtain an aqueous white paint S35.

### Example 3-4 (Aqueous White Paint S36)

9.3 g of the aqueous dispersion LAW295a and 10.7 g of the acrylic acid-type binder VSR-50 were mixed, in which the pigment volume concentration was 28%. The mixture was stirred at a rotation speed of 800 rpm to 1000 rpm for 0.5 hours to obtain an aqueous white paint S36.

### Example 3-5 (Aqueous White Paint S80)

6.4 g of the aqueous dispersion LAW346a and 13.6 g of the acrylic acid-type binder VSR-50 were mixed, in which the pigment volume concentration was 18%. The mixture was stirred at a rotation speed of 800 rpm to 1000 rpm for 0.5 hours to obtain an aqueous white paint S80.

### Example 3-6 (Aqueous White Paint S81)

9.1 g of the aqueous dispersion LAW346a and 10.9 g of the acrylic acid-type binder VSR-50 were mixed, in which the pigment volume concentration was 28%. The mixture was stirred at a rotation speed of 800 rpm to 1000 rpm for 0.5 hours to obtain an aqueous white paint S81.

### Example 3-7 (Aqueous White Paint S82)

8.7 g of the aqueous dispersion LAW346a and 11.3 g of poly(acrylic acid) binder ESP-2293 (commercially available from ESP materials) were mixed, in which the pigment volume concentration was 28%. The mixture was stirred at a rotation speed of 800 rpm to 1000 rpm for 0.5 hours to obtain an aqueous white paint S82.

### Example 3-8 (Aqueous White Paint S83)

8.5 g of the aqueous dispersion LAW346a and 11.5 g of poly(acrylic acid)-type binder SP-3901 (commercially available from Gelie Chemical) were mixed, in which the pigment volume concentration was 28%. The mixture was stirred at a rotation speed of 800 rpm to 1000 rpm for 0.5 hours to obtain an aqueous white paint S83.

### Example 3-9 (Aqueous White Paint S84)

8.7 g of the aqueous dispersion LAW346a and 11.3 g of polyurethane-type binder 2026C (commercially available from UNION CHEMICAL IND. CO., LTD.) were mixed, in which the pigment volume concentration was 28%. The mixture was stirred at a rotation speed of 800 rpm to 1000 rpm for 0.5 hours to obtain an aqueous white paint S84.

The viscosity of the aqueous white paint at a rotation speed of 1000 rpm and temperature of 25° C. and the average diameter (Dₐᵥₑ) of the TiO₂ powder in the paint are tabulated in Table 2.

TABLE 2

| | | Pigment | | | | | | |
|---|---|---|---|---|---|---|---|---|
| | | volume | Dispersion | Dispersion | | Paint | | |
| | | concentration | (White | Dₐᵥₑ | Viscosity | Dₐᵥₑ | ΔDₐᵥₑ | Viscosity |
| Paint | Dispersant | (%) | slurry) | (nm) | (cps) | (nm) | (nm) | (cps) |
| S13 | — | 18 | Kronos 4311 | 319 | 37 | 642 | 323 | 31 |
| | | | | | | | (+101%) | |
| S14 | — | 28 | Kronos 4311 | 319 | 37 | 657 | 338 | 43 |
| | | | | | | | (+106%) | |
| S80 | 5d | 18 | LAW346a | 292 | 32 | 449 | 157 | 35 |
| | | | | | | | (+54%) | |
| S81 | 5d | 28 | LAW346a | 292 | 32 | 429 | 137 | 53 |
| | | | | | | | (+47%) | |
| S82 | 5d | 28 | LAW346a | 292 | 32 | 442 | 150 | 27 |
| | | | | | | | (+51%) | |
| S83 | 5d | 28 | LAW346a | 292 | 32 | 461 | 169 | 38 |
| | | | | | | | (+58%) | |
| S84 | 5d | 28 | LAW346a | 292 | 32 | 304 | 12 | 31 |
| | | | | | | | (+4%) | |

The dispersion formed from the aqueous polymer dispersant prepared in Examples of the disclosure could be mixed with the binder resin to form the paints, and the average diameter of the TiO₂ powder in the paints would not greatly increase (compared to the commercially available white slurry).

### Example 4 (Gloss Comparison)

The aqueous white paint S14 (containing commercially available white slurry Kronos 4311) and the aqueous white paint S81 (containing the dispersion LAW346a) were respectively coated onto glass substrates by No. 22 wire rod to form wet films having a thickness of about 50.29 μm. The wet films were dried to obtained white films. In a gloss meter ZEHNTNER ZGM 1120, the white films were respected irradiated by an incident light of 60° to measure their gloss. The white film formed from the aqueous white paint S81 had a gloss of 86.4, and the white film formed from the aqueous white paint S14 was 62.2. Obviously, the aqueous polymer prepared in Examples of the disclosure could be used for the aqueous white paint to efficiently increase the product gloss.

### Example 5 (Opacity Comparison)

The aqueous white paint S13 (containing the commercially available white slurry Kronos 4311), the aqueous white paint S80 (containing the dispersion LAW346a), the aqueous white paint S14 (containing the commercially available white slurry Kronos 4311), the aqueous white paint S35 (containing the dispersion LAW294a), the aqueous white paint S36 (containing the dispersion LAW295a), and the aqueous white paint S81 (containing the dispersion LAW346a) were respectively coated on BYK opacity test papers (PA-2814) by No. 22 wire rod to form wet films having a thickness of 50.29 μm. The wet films were dried to obtain white films. The opacity of the white films was measured by image analyzer QEA IAS according to the standard ASTM D2805. In the aqueous white paint having a pigment volume concentration of 18%, the white film formed from the aqueous white paint S13 had a reflectivity (Y value) of 82.0 on the black bottom and a reflectivity (Y value) of 90.7 on the white bottom, which means that the white film had an opacity of 90.4%; and the white film formed from the aqueous white paint S80 had a reflectivity (Y value) of 84.0 on the black bottom and a reflectivity (Y value) of 90.6 on the white bottom, which means that the white film had an opacity of 92.7%. In the aqueous white paint having a pigment volume concentration of 28%, the white film formed from the aqueous white paint S14 had a reflectivity (Y value) of 85.6 on the black bottom and a reflectivity (Y value) of 91.9 on the white bottom, which means that the white film had an opacity of 93.1%; the white film formed from the aqueous white paint S35 had a reflectivity (Y value) of 84.6 on the black bottom and a reflectivity (Y value) of 91.5 on the white bottom, which means that the white film had an opacity of 92.5%; the white film formed from the aqueous white paint S36 had a reflectivity (Y value) of 84.1 on the black bottom and a reflectivity (Y value) of 91.8 on the white bottom, which means that the white film had an opacity of 91.6%; and the white film formed from the aqueous white paint S81 had a reflectivity (Y value) of 85.7 on the black bottom and a reflectivity (Y value) of 91.4 on the white bottom, which means that the white film had an opacity of 93.8%. Accordingly, the aqueous polymer prepared in Examples of the disclosure could be used in aqueous white paint to efficient increase the product opacity.

### Example 6

The aqueous white paints S14, S35, S36, and S81 were respectively coated on glass substrates by No. 22 wire rod to form films to measure their chromaticity coordinates (X, Y, Z). The films were heated to 210° C. and kept for 1 and 2 hours to measure their chromaticity coordinates again. The product utilizing the aqueous polymer 5d as the dispersant had a lower yellowing degree (e.g. ΔYI), and the products containing the commercially available dispersant BYK190 or BYK199 or the commercially available white slurry Kronos 4311 had a higher yellowing degree. For example, the film formed from the white paint S14 had a ΔYI value of 4.6 (second grade yellowing, or a slight color change) after being heated for 1 hour, and a ΔYI value of 14.7 (fifth grade yellowing, or a serious color change) after being heated for 2 hours. The film formed from the white paint S35 had a ΔYI value of 2.5 (first grade yellowing, or a very slight color change) after being heated for 1 hour, and a ΔYI value of 7.5 (third grade yellowing, or an obvious color change) after being heated for 2 hours. The film formed from the white paint S36 had a ΔYI value of 5.7 (second grade yellowing, or a slight color change) after being heated for 1 hour, and a ΔYI value of 11.6 (fourth grade yellowing, or a great color change) after being heated for 2 hours. The film formed from the white paint S81 had a ΔYI value of 1.3 (zero grade yellowing, or no color change) after being heated for 1 hour, and a ΔYI value of 5.4 (second grade yellowing, or a slight color change) after being heated for 2 hours. ΔYI value (yellow difference) is defined as below: YI=100(1.30*X−1.13*Z)/Y, ΔYI=(YI after heating)−(YI before heating). ΔYIJ 1.5 is zero grade, which means no color change. 1.6<ΔYI≤3.0 is first grade, which means very slight color change. 3.1<ΔYI≤6.0 is second grade, which means slight color change. 6.1<ΔYI≤9.0 is third grade, which means obvious color change. 9.1<ΔYI≤12.0 is fourth grade, which means great color change. 12.1<ΔYI is fifth grade, which means serious color change.

### Example 7 (Neutralizers Comparison)

The aqueous polymer 5d (neutralized with ammonia) and the aqueous polymer 5d″ (neutralized with triethanolamine) were transparent, clear, and pale yellow. Both of the aqueous polymers 5d and 5d″ were heated to 120° C. and kept at 120° C. for 2 hours. The heated aqueous polymer 5d was still transparent, clear, and pale yellow. However, the heated aqueous polymer 5d″ changed to dark yellow. Accordingly, the tertiary amine was not suitable to form the aqueous polymer of the disclosure.

It will be apparent to those skilled in the art that various modifications and variations can be made to the disclosed methods and materials. It is intended that the specification and examples be considered as exemplary only, with the true scope of the disclosure being indicated by the following claims and their equivalents.

What is claimed is:

1. An aqueous polymer, being:
formed by neutralizing a copolymer modified by polyalkylene glycol with ammonia, primary amine, secondary amine, or a combination thereof,
wherein the copolymer is copolymerized from an anhydride monomer with a double bond, a monomer with a double bond, and an initiator.

2. The aqueous polymer as claimed in claim 1, wherein the initiator comprises dibenzamidine peroxide, 2,2′-azobisisobutyronitrile, di(t-butyl) peroxide, t-butylhydroperoxide, 1,1′-azo(cyanocyclohexane), 2,5-dimethyl-2,5-bis(t-butyl peroxide) hexane, t-butyl pexoyxbenzoate, cumene hydroperoxide, dicumyl peroxide, lauryl peroxide, or t-butyl peroxyacetate.

3. The aqueous polymer as claimed in claim 1, having a chemical structure of 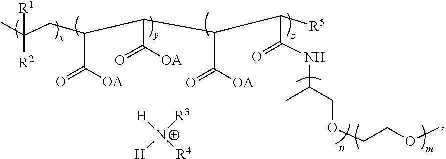
wherein R¹ is H or methyl group,
R² is C₆₋₁₂ aryl group, C₃₋₁₂ heteroaryl group, C₂₋₁₀ aliphatic group, —(C═O)—OA, or a combination thereof,
R³ is H, C₁₋₄ alkyl group, or C₁₋₄ alkyl alcohol;
R⁴ is H, C₁₋₄ alkyl group, or C₁₋₄ alkyl alcohol;
R⁵ is H, methyl group, phenyl group, cumyl group, cumyl ester group, cumyl ether group, t-butyl ether group, benzoate group, cyanocyclohexane group, isobutyronitrile group, C₂₋₁₁ alkyl group, C₂₋₁₁ alkyl ester group, C₆₋₁₂ aryl group, C₃₋₁₂ heteroaryl group, or C₂₋₁₀ aliphatic group;
each of A is independently ^{⊖} or H, and at last one of A is ^{⊖};
x is 8 to 21;
y is 3 to 9;
z is 1 to 5;
m is 10 to 70; and
n is 1 to 13.

4. The aqueous polymer as claimed in claim 3, wherein 0.1≤z/(y+z)≤0.5.

5. The aqueous polymer as claimed in claim 1, having an acid value of 40 mgKOH/g to 250 mgKOH/g.

6. A dispersion, comprising:
an aqueous polymer;
water; and
pigment powder,
wherein the aqueous polymer is formed by neutralizing a copolymer modified by polyalkylene glycol with ammonia, primary amine, secondary amine, or a combination thereof,
wherein the copolymer is copolymerized from an anhydride monomer with a double bond, a monomer with a double bond, and an initiator.

7. The dispersion as claimed in claim 6, wherein the aqueous polymer has a chemical structure of 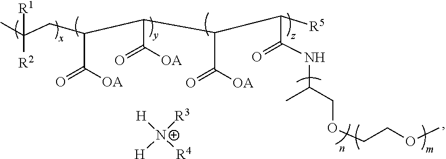
wherein R is H or methyl group,
R² is C₆₋₁₂ aryl group, C₃₋₁₂ heteroaryl group, C₂₋₁₀ aliphatic group, —(C═O)—OA, or a combination thereof,
R³ is H, C₁₋₄ alkyl group, or C₁₋₄ alkyl alcohol;
R⁴ is H, C₁₋₄ alkyl group, or C₁₋₄ alkyl alcohol;
R⁵ is H, methyl group, phenyl group, cumyl group, cumyl ester group, cumyl ether group, t-butyl ether group, benzoate group, cyanocyclohexane group, isobutyronitrile group, C₂₋₁₁ alkyl group, C₂₋₁₁ alkyl ester group, C₆₋₁₂ aryl group, C₃₋₁₂ heteroaryl group, or C₂₋₁₀ aliphatic group;
each of A is independently ^{⊖} or H, and at last one of A is ^{⊖};
x is 8 to 21;
y is 3 to 9;
z is 1 to 5;
m is 10 to 70; and
n is 1 to 13.

8. The dispersion as claimed in claim 6, wherein the pigment powder has an average diameter of 280 nm to 400 nm.

9. An aqueous paint, comprising:
a dispersion and a binder,
wherein the dispersion comprises:
an aqueous polymer;
water; and
pigment powder,
wherein the aqueous polymer is formed by neutralizing a copolymer modified by polyalkylene glycol with ammonia, primary amine, secondary amine, or a combination thereof,
wherein the copolymer is copolymerized from an anhydride monomer with a double bond, a monomer with a double bond, and an initiator.

10. The aqueous paint as claimed in claim 9, wherein the aqueous polymer has a chemical structure of 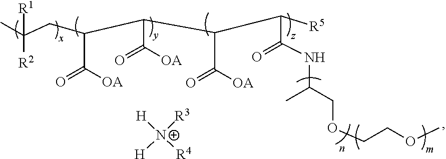
wherein R is H or methyl group,
R² is C₆₋₁₂ aryl group, C₃₋₁₂ heteroaryl group, C₂₋₁₀ aliphatic group, —(C═O)—OA, or a combination thereof,
R³ is H, C₁₋₄ alkyl group, or C₁₋₄ alkyl alcohol;
R⁴ is H, C₁₋₄ alkyl group, or C₁₋₄ alkyl alcohol;
R⁵ is H, methyl group, phenyl group, cumyl group, cumyl ester group, cumyl ether group, t-butyl ether group, benzoate group, cyanocyclohexane group, isobutyronitrile group, C₂₋₁₁ alkyl group, C₂₋₁₁ alkyl ester group, C₆₋₁₂ aryl group, C₃₋₁₂ heteroaryl group, or C₂₋₁₀ aliphatic group;
each of A is independently ^{⊖} or H, and at last one of A is ^{⊖};
x is 8 to 21;
y is 3 to 9;
z is 1 to 5;
m is 10 to 70; and
n is 1 to 13.

11. The aqueous paint as claimed in claim 9, wherein the pigment powder has an average diameter of 280 nm to 500 nm.
